(19) United States
(12) Patent Application Publication
(10) Pub. No.: US 2015/0185872 A1
(43) Pub. Date: Jul. 2, 2015

(54) GLOVE FOR USE WITH CAPACITIVE TOUCH SCREEN AND METHOD OF MANUFACTURING SAME

(71) Applicant: Gerald Leto, San Jose, CA (US)

(72) Inventor: Gerald Leto, San Jose, CA (US)

(21) Appl. No.: 14/588,028

(22) Filed: Dec. 31, 2014

Related U.S. Application Data
(60) Provisional application No. 61/923,061, filed on Jan. 2, 2014.

(51) Int. Cl. G06F 3/039; A41D 19/04; A41D 19/00; G06F 3/0354; G06F 3/044

(52) U.S. Cl. CPC G06F 3/039; G06F 3/03545; G06F 3/044; A41D 19/00; A41D 19/04; G06F 2203/0331

(57) ABSTRACT

A modified material for use with a capacitive touch screen is described. The modified material comprises backcoating the material with a composition comprising either a non-metallic and/or a metallic conductive agent. A variety of materials are contemplated, including, but not limited to leather. Also described is an apparatus and method of making the conductive glove.

### CROSS-REFERENCE TO RELATED APPLICATIONS

The present application claims the benefit of provisional patent application No. 61/923,061, filed Jan. 2, 2014, and entitled “GLOVE FOR USE WITH CAPACITIVE TOUCH SCREEN AND METHOD OF MANUFACTURING SAME.”

### BACKGROUND OF THE INVENTION

1. Field of the Invention

This relates generally to a modified material that is capable of operating a capacitive touch screen. The material is impregnated with a composition comprising either a metallic or a non-metallic conductive agent and a binder. More particularly, a glove is described that is capable of capacitive coupling to a touch screen.

2. Background

Multi-touch mobile phones and handheld devices are becoming ever popular.

However, the user can not interface with these multi-touch devices, as intended, when the user of the device is wearing gloves or is otherwise unable to touch the screen with their skin. This can particularly be a problem in, for example, northern or southern hemisphere countries when the weather is colder. However, even for short periods of cold weather, like during skiing, operation of touch mobile devices is a problem. Additionally, certain occupations require or suggest the use of gloves to protect the hands from injuries, such as contractors, product delivery drivers, military and public safety personnel. There are also certain transportation and recreational activities where the use of gloves might be used, such as, golfers, motorcycle riders and gardeners, who desire to operate their touch screen devices.

A popular form of the touch screen device includes a multi-touch touch screen which operates using capacitive technology. With reference to FIG. 11, for example, an electromagnetic (EM) field 620 for a capacitive system is shown being tuned to just above the surface layer of the glass panel of the monitor of the touch screen. When a user touches the monitor with his or her finger, the EM field is attenuated, some of the charge is transferred to the user, and the electromagnetic discharge is registered by the touch screen device's central processing unit as a touch. This is a form of capacitive coupling between the user and the capacitive touch screen. This decrease is measured by circuits located at each corner of the monitor. A processor of the touch screen device calculates, from the relative differences in charge at each corner, exactly where the touch event took place and then relays that information to the touch-screen driver software.

A problem surrounding capacitive touch screens is that they rely upon an electrical response (transfer of charge or capacitive coupling) from or to the user's fingertips. Gloves and prosthetic devices, unsurprisingly, prevent the electrical charge from passing through the material. Therefore, one is required to remove a glove whenever activating the device, e.g., when making a phone call, sending a text a message, or checking email.

A challenge in the production of touch screen compatible gloves is the need to surface coat the textiles or materials with an electrically conductive coating and binder and then to cover the material with a color coating. Generally speaking, current methods to produce gloves operable with a capacitive-based touch screen use conductive threads, conductive patches and conductive coatings which are applied to the front surface of the textiles, fabric and leather. Undesirably, the conductive materials (an essential element for the glove to properly operate with the capacitance-based touch screen) are subject to abrasive wear. When the electrically conductive materials wear off by normal use, the gloves no longer function. Additionally, covering the front surface undesirably impacts the material's natural surface color and texture. Additionally, certain other properties, such as waterproofing or softening agents, are no longer possible.

Thus, there is a need for a material and a method of producing a material that provides a user with the typical benefits provided by gloves, but additionally allows the user to operate a touch-screen device without having to remove the glove or otherwise put their skin in contact with the touch screen. Additionally, there is a need for a method of producing the material and glove such that the electrically conductive agent is less subject to being damaged and worn off. Additionally, there is a need for a method of producing a touch screen compatible glove that appears to be no different than a non-touch screen compatible glove.

### SUMMARY OF THE INVENTION

The description, objects and advantages of the present invention will become apparent from the detailed description to follow, together with the accompanying drawings.

In order to properly operate a capacitive touch screen device with gloves on or without the ability to contact human skin and without the use of a device, such as a stylus or other embodiment specifically created for this purpose, the glove or other material must provide enough electrical capacity to operate the touch screen. Materials of this invention provide the requisite electrical capacity to perform in such a manner, thereby allowing for operation of the touch screen absent human conductive coupling to the device.

In embodiments, a method of producing an electrically conductive glove material includes a back coating treatment which produces a glove operable to capacitively couple to the touch screen in the same way as if the front surface of the glove were treated with electrically conductive agents and binders.

Embodiments of the present invention operate to attenuate the electromagnetic field as if a human finger was touching the capacitive based touch screen. Without being bound by theory, a human finger, below the surface of the skin, comprises water and the presence of the water is what attenuates the electromagnetic field. FIG. 11 illustrates attenuation of the EM field by a finger. In particular, the subcutaneous water layer 622 in the finger 624 is shown penetrating the EM field 620. The screen is typically adapted to detect a 4.5 mm diameter touch.

In embodiments, a glove material is coated or penetrated with a layer of conductive material that can effectively attenuate the EM field and capacitively couple to the capacitive touch screen devices as though being touched by human skin. The glove functions regardless of what color or properties are added to the outer surface, or what type of raw material is used in the manufacture of the glove. The glove material may vary widely. Examples of glove raw materials include leather, fabric, textiles, and rubbers (e.g., silicone rubber).

In embodiments, for leather and textiles having thicknesses less than or equal to the average thickness of human skin, the back side is treated with a conductive coating or layer that is the volumetric equivalent of the conductive properties of the human body, resulting in the treated materials being able to capacitively couple.

In embodiments, for leather having a thickness greater than the average thickness of human skin, methods include impregnating the collagen fibers with electrically conductive agents and binders. Volumetric uptake of the conductive agents and binders into the collagen fibers are performed at least to the extent to replicate water in the human skin and not change the surface property of the leather. In embodiments, methods may be used to impregnate the electrically conductive agents similar to the method for treating the leather as described herein.

In embodiments, a removable masking agent is first applied to the surface of the textiles and leather to block or repel the absorption of the chemistry to the protected regions/sections. The mask prevents the electrically conductive agents from seeping through to the protected “masked regions.” After processing, and when the conductive agent application is complete, the mask is removed.

In embodiments, processes and methods are carried out such that the original surface of the textiles or leather are left unchanged by the treatment system.

In one embodiment, the invention is directed to a modified material comprising a material impregnated with a composition comprising a non-metallic electrically conductive agent and a binder at a sufficient concentration to provide electrical conductivity in the impregnated material. In another embodiment, the material is impregnated with a metallic electrically conductive agent. In another embodiment, the material is textile, leather, nonwoven material, or a leather-like material. In another embodiment, the material has a volume resistivity of less than about 1.0×10⁸ Ohm-cm or less than about 1.0×10⁷ Ohm-cm, or less than about 1.0×10⁶ Ohm-cm, or less than about 1.0×10⁵ Ohm-cm or less than about 1.0×10⁴ Ohm-cm.

The invention is also directed to a method of operating a capacitive touch screen by placing the modified material of the invention in proximity to the touch screen in a manner that allows for operation of the touch screen.

In one embodiment, a glove comprises the modified material described above. In another embodiment, a user wearing the glove may operate a capacitive touch screen.

One additional embodiment includes a conductive glove. The conductive glove optionally includes a liner, wherein the liner is less than 2 mm thick and for has a volume resistivity of less than 1.0×10⁷ Ohm-cm. The conductive glove further includes an electrically conductive thermal insulator layer adjacent to the liner, and optionally an outer shell adjacent to the electrically conductive insulating layer, wherein the outer shell has a volume resistivity of less than 1.0×10⁷ Ohm-cm.

Another embodiment includes a conductive glove. The conductive glove includes an outer shell. The outer shell includes at least one conductive channel, wherein at least one the conductive channel extends from an inner surface of the outer shell to an outer surface of the outer shell, and the conductive channel has a volume resistivity of less than 1.0×10⁷ Ohm-cm.

A conductive glove for use with capacitive based touch screen displays, said glove comprising a glove material including a front surface and a back surface; a plurality of cavities extending into the glove material from the back surface, said cavities not extending all the way through the glove material to the front surface; and a conductive material filling the cavities.

The glove wherein the cavities extend to a floor surface, said floor surface being less than 1 mm, and in some embodiments, less than or equal to about 0.03 inches from the front surface of the glove material.

In embodiments, the glove material is leather.

A method of manufacturing a glove for use with capacitive based touch screen displays comprising: puncturing a back surface of a glove material with an array of pins to create a plurality of cavities in the back surface of the glove material wherein the cavities do not extend completely through the glove material; and filling the cavities with a conductive material.

The method wherein the puncturing step is performed by supporting the glove material on a rigid substrate, and rolling a pin wheel comprising the array pins across the glove material.

The method wherein the cavities extend to a floor surface, and said floor surface being less than 1 mm, and in some embodiments, less than or equal to about 0.03 inches from the front surface of the glove material.

In embodiments, the cavities extend to a floor surface, and the floor surface being less 0.2 mm from the front surface of the glove material.

The method wherein a pin to pin distance (or the well to well distance) ranges from 2-5 mm.

The method wherein the array of pins comprise a diamond pattern.

The method wherein the pins comprise a bullet nose shape.

The method wherein the pins are 18-20 gauge.

A method of making a glove comprising impregnating the back of a leather material with a solution comprising electrically conductive agents such that the electrically conductive agents do not penetrate to within T_{L} from the front of the leather material.

A method of making a glove comprising impregnating the back of a material with a solution comprising electrically conductive agents such that the electrically conductive agents do not penetrate to within T_{S} from the front of the material.

A method of making a glove comprising coating the back of a raw material with a solution comprising electrically conductive agents such that the electrically conductive agents do not penetrate to within T_{S} from the front of the raw material.

A method of making an electrically conductive glove from a glove material, the method comprising: measuring the thickness of the glove material; determining a target volumetric uptake or depth of penetration value based on the thickness of the glove material; applying an EC solution to the back of the glove material; measuring the volumetric uptake of the EC solution into the material; and adjusting at least one process condition based on the measuring step and the determining step.

A tool for creating a plurality of cavities in a textile material comprising a pin wheel as described herein.

An electrically conductive glove for operating a capacitive touch screen as described herein.

A method of manufacturing an electrically conductive glove as described herein.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a cross-section of an embodiment of an electrically conductive glove.

FIG. 2 shows a cross-section of another embodiment of an electrically conductive glove.

FIG. 3 shows a cross-section of another embodiment of an electrically conductive glove.

FIG. 4 shows a cross-section of another embodiment of an electrically conductive glove.

FIG. 5 shows a partial cross-section of another embodiment of an electrically conductive glove material having cavities.

FIGS. 6a-6b show front and side views respectively of a manufacturing tool comprising pins to create the cavities a glove material.

FIGS. 7-9 show cross sections of various electrically conductive glove materials.

FIG. 10 is an illustration of a capacitive touch screen and attenuation of an EM field from a glove made in accordance with embodiments of the present invention.

FIG. 11 is an illustration of a capacitive touch screen and attenuation of an EM field from a human finger.

### DETAILED DESCRIPTION OF THE INVENTION

Prior to discussing the invention, all numerical designations, e.g., pH, temperature, time, concentration, and molecular weight, including ranges, are approximations which are varied (+) or (−) by increments of 5%. It is to be understood, although not always explicitly stated that all numerical designations are preceded by the term “about”. It also is to be understood, although not always explicitly stated, that the reagents described herein are merely exemplary and that equivalents of such are known in the art.

All patents and publications cited herein are incorporated herein by reference in their entirety. Provisional patent application No. 61/923,061 to Leto, and international patent application PCT/US2010/037286 to Leto et al are incorporated by reference in their entirety. Nothing herein is to be construed as an admission that the invention is not entitled to antedate such disclosure by virtue of prior invention.

As used herein, the term “comprising” is intended to mean that the compositions and methods include the recited elements, but do not exclude others. “Consisting essentially of” when used to define compositions and methods, shall mean excluding other elements of any essential significance to the combination for the intended use. Thus, a composition consisting essentially of the elements as defined herein would not exclude trace contaminants from the isolation and purification method and pharmaceutically acceptable carriers, such as phosphate buffered saline, preservatives, and the like. “Consisting of” shall mean excluding more than trace elements of other ingredients and substantial method steps for administering the compositions of this invention. Embodiments defined by each of these transition terms are within the scope of this invention.

It is also to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Lastly, unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, examples of methods, devices, and materials are now described.

Materials

The invention is directed to, in part, a modified material comprising a material impregnated with a composition comprising a non-metallic electrically conductive agent and a binder at a sufficient concentration to provide electrical conductivity in the impregnated material. What is meant by the term “impregnate” is that the material is somehow filled or infused with the composition. In some embodiments, the material is coated. In other embodiments, the composition fills voids or interstices of the material. This can be accomplished in a variety of ways, including but not limited to spraying, drying, curing, soaking, rinsing, or combinations of a variety of treatments and the like. For example, the composition may be applied to a material by spraying and then drying the material with or without heat. This is more thoroughly described in the next section.

It is contemplated that the materials of the invention may include, but are not limited to, textiles, leathers, nonwoven materials, and a leather-like materials. It is contemplated that the materials of the invention comprise some voids or interstices to allow for effective impregnation of the conductive agents. These materials may include, but are not limited to, leather, faux leather, suede, faux suede, polymer, wool, cotton, fur, nylon, fleece, fabric, cloth, woven and knitted materials, polyester, nylon, synthetic fabrics, rubber, latex, neoprene and the like.

As used herein the term “conductive agent,” also referred to herein as “electrically conductive filler material, refers to an agent that is electrically conductive. In some embodiments, the agent is biocompatible, meaning it is compatible with human tissue. In certain embodiments, the conductive agent comprises conductive particles and/or conductive fibers. The nonmetallic conductive agent include, but are not limited to, carbon black, carbon nanotubes, graphite, PEDOT, and combinations thereof. In certain embodiments, the conductive agent comprises carbon fiber chains with at least some of the carbon fiber chains having a length of greater than 100 nanometers. In other embodiments, the agent is long chain carbon black.

The non-metallic conductive agent may also be a polymer. Representative polymers include poly(acetylene)s, poly(pyrrole)s, poly(thiophene)s, polyanilines, polythiophenes, poly(p-phenylene sulfide), and poly(para-phenylene vinylene)s (PPV), polyindole, polypyrene, polycarbazole, polyazulene, polyazepine, poly(fluorene)s, and polynaphthalene and combinations thereof.

The term “metallic conductive agents” refers to a variety of conductive metals. Those metals include silver, copper, gold, nickel, aluminum, indium, zinc, tin, tantalum, magnesium, sodium, beryllium, barium, cadmium, calcium, rubidium, cesium, lithium, molybdenum, cobalt, uranium, chromium, manganese, iron, platinum, tungsten, osmium, titanium, iridium, ruthenium, nickel, rhodium, palladium, steel, thallium, lead, niobium, vanadium, arsenic, antimony, mercury, bismuth, tellurium and combinations or alloys thereof. In certain embodiments, the metallic agent may be selected from the group consisting of silver, copper, gold, nickel, aluminum, indium, zinc, tin, and combinations or alloys thereof.

Whether employing a metallic or non-metallic conductive agent, the conductive agent may serve as a coating to another particle or fiber. For example, silver-coated glass beads and silver-coated fiberglass are useful in materials of the invention. Further, it is also contemplated that a combination of conductive agents may be used. For example, silver-coated glass beads can be used in conjunction with carbon black.

The amount of conductive agent required can be readily determined by one of skill in the art based on the conductivity of the agent selected. For example, it is contemplated that for some conductive agents, the modified material will be comprised of at least about 30% of conductive agent. When selecting the amount of conductive agent, the desired conductivity should be considered. For example, the modified materials of the invention have a volume resistivity of less than about 1.0×10⁸ ohm-cm or less than about 1.0×10⁷ ohm-cm or less than about 1.0×10⁵ ohm-cm or less than about 1.0×10⁴ ohm-cm. Further, the modified material retains similar volume resistivity after any pre-commercialization treatments, such as stretching, bending, deforming and the like. It is also contemplated that the materials of the invention retain their conductivity after being used for about 1 month or longer. It is contemplated that the modified material of the invention retains its conductivity for at least about 6 months or at least a year.

In other embodiments, the conductive agent is substantially homogeneously dispersed or suspended with a binder. Any number of suitable binders will suffice and can be readily determined by one of skill in the art based on material on which it is being applied. The composition may also optionally comprising aqueous polyether polyurethanes, solvent-borne polyether/polyester, aqueous acrylics, styrene butadiene rubber, nitrocellulose lacquers and water emulsions, cellulose acetate butyrate lacquers and water emulsions, shellac, epoxy, polyvinyl chloride, oils, waxes, silicones, and/or combinations thereof. Additional components include dyes and pigments, ionic additives, pH balancers, fastness agents, water, adhesion promoters, bonding agents, aromatic polyurethanes, aliphatic polyurethanes, carriers including resins, binders, cross-linking agents, acrylics, UV protective additives, feel enhancers, and the like.

In certain embodiments the material optionally has any number of additional coats, such as for example, a base coat, a midcoat, a color coat, and a top or finishing coat. The additional components may be in any number of additional coats just described. Further, the composition comprising the conductive agent can be applied in a base coat, a midcoat, a color coat, and/or the top coat. In one embodiment, the top coat comprises cellulose acetate butyrate.

Leather Materials

The invention is also directed to leather products, including, but not limited to, black leather products and red leather products that are electrically conductive. The leather products or materials of the invention may be created in the following method.

A tanned leather (crust) is obtained. This leather may be tanned with conventional tanning agents, including chromium and or aluminum salts, vegetable based tannins, etc. The tanned leather is then colored by tumbling in a tumbling drum, using one or more of the following in solution: dyes, ionic additives, pH balancers, fastness agents, and/or water.

Once the coloring process is complete, the leather is toggled. Toggling involves stretching the leather while wet to some percentage of the maximum stretch to which the leather can accept. For the leather materials of the current invention, the leathers are toggled to between 25% and 75% of the maximum toggling, and preferably to 50% of the maximum toggling. While stretched (toggled), the leather material is then dried, after which the dried leather is removed from the stretching fixture.

The leather material is then optionally coated with a base coat. Said base coat comprises one or more of the following: (1) electrically conductive filler material (for example carbon black particles such as Ashbury 5303 long chain carbon black, silver particles, silver coated silicates, silver coated copper particles, copper particles, nickel, tin, or aluminum particles or coated particles, conductive or coated fibers or particles, etc.); (2) adhesion promoters; (3) bonding agents; (4) paints or other coloring agents; (5) aromatic polyurethane; (6) aliphatic polyurethane; (7) other carriers, including but not limited to resins, binders, cross linking agents, acrylics, etc.

This coating process is typically accomplished by spraying said coating onto the leather surface, and said additives and binders cause said base coat to bond to said leather material. Said long chain carbon black forms long chain-like electrically conductive pathways within the coating layer and the surface of the porous base leather material in such a manner that said coated leather material maintains its conductivity and capacitance when said leather material is bent, stretched, or otherwise deformed. The coating is then cured (dried) either under heat or air dried without heat. The resulting coating is both electrically conductive (with an electrical conductivity below about 1.0×10⁵ Ohm-cm and chemically and/or mechanically bonded to the leather material.

A mid-coat optionally is then applied, comprising one or more of the following: (1) aromatic polyurethane; (2) aliphatic polyurethane; (3) conductive fillers and/or (4) water.

This mid-coat is cured with or without heat. Said mid-coat is applied with electrically conductive fillers in such a concentration and in such a manner that said conductive fillers form conductive pillar structures that bridge the thickness of said mid-coat, providing electrically conductive continuity between the surface of said mid-coat and said base coat.

A finish, or top, coat is then applied to the leather material to further condition the material by adding abrasion resistance, water proofing, fire resistance, look and feel enhancement etc. The finish coating may be comprised of one or more of the following constituents: polyurethanes; acrylics; binders; look and feel enhancers; waxes; silicones; electrically conductive fillers; UV protective additives; and/or water.

This coating may be applied very lightly to ensure electrical conductivity with and/or electrical capacitive coupling to the base coating. Alternately, the finish coating may be loaded with conductive fillers in such a manner that said electrically conductive fillers form electrically conductive pillars, or electrically conductive pathways, between the outer surface of said finish coat and said electrically conductive mid- and base coatings.

The leather material then undergoes a final curing step in which the finish coating is cured, typically with heat, but alternately without heat. After the final coating the leather is milled, by tumbling the leather material in a tumbler to restore flexibility, softness, and/or suppleness.

Although the above method is specifically used for leather materials, the coatings and coating processes may be used on other materials such as artificial leathers, and woven or non-woven fabric textiles such as cotton, polyester fiber, nylon fiber, vinyl fiber, silk, wool, lyocell, or other natural or artificial fibers.

The above described method of the invention produces a leather or other material that is highly conductive, with a volume resistivity below about 1.0×10⁵ Ohm-cm, and/or has a capacitance approximately equivalent to that of the human body. This capacitance may be as low as 10 pico-Farads (pF), or higher, with respect to a distant ground.

The electrically conductive and capacitive materials of the invention may be then used in conventional or non-conventional methods to produce garments and various products, such as gloves, jackets, shirts, pants, coats, body suits, wet suits, boots, socks, hats, other clothing items, backpacks, belts, straps, bags, parachutes, upholstery, bedding, curtains, carpeting, computer bags, travel bags, duffel bags, etc.

The finished conductive and/or capacitive leather material of the invention exhibits several functional, morphological, and structural characteristics. The first of said functional characteristics is said leather material's low electrical resistivity, as measured between two points on the coated surface of said leather material. The electrical resistivity of said coated leather material may be expressed as a surface resistivity or as a volume resistivity. The surface resistivity of the leather material of the invention is less than 1.0×10⁶ Ohm/square, and the volume resistivity is less than 1.0×10⁵ Ohm-cm.

The next of said functional characteristics is said leather material's high capacitance with respect to a distant ground. The capacitance of said electrically capacitive leather material is greater than 10.0 pF.

The next of said functional characteristics is said leather material's ability to maintain said low electrical resistivity and high capacitance when said leather material is stretched, twisted, bent, wrinkled, braided, etc., without significant degradation to said electrical properties.

The above mentioned functional characteristics are a result of one or more of the following morphological and structural characteristics. The first of said morphological and structural characteristics is penetration of the base coat into the porous and/or fibrous surface of said leather material. During the coating process, one or more solvents, carriers, surfactants, polymers, or other liquids carries the electrically conductive particles and/or fibers into the porous surface of said leather material. During the ensuing curing process, one or more of said solvents, carriers, surfactants, polymers or other liquids evaporates and or cross links, and/or cures, leaving the interstitial porous structure of said leather material substantially filled with said electrically conductive particle and/or fiber material. Additionally, one or more polymers, waxes, fillers, binders, adhesives, or other materials may remain with said electrically conductive material in said porous or fibrous structure of said leather material after curing. This interstitially penetrated material combination forms a matrix of said electrically conductive materials, said binders, adhesives, polymers, waxes, etc. that is electrically conductive, possesses a capacitance with respect to a distant ground, and not easily removed from the surface of said leather material.

The next of said morphological and structural characteristics is the existence of a dense layer of electrically conductive material, such as carbon black, on the surface of the coated base layer of said leather material. The electrically conductive material in said base layer may be of sufficient concentration, buoyancy, surface tension, or other property to allow said electrically conductive material to form a surface layer during the spray coating and/or curing process. Said surface layer acts as a highly electrically conductive layer on said leather material, enabling both low electrical resistivity and high electrical capacitance.

The next of said morphological and structural characteristics is the existence of pillar like structures of conductive particles and/or fibers within one or more of the coating layers of said electrically conductive and capacitive leather material. During the coating and/or curing process, said electrically conductive particles and/or fibers in said coating form closely packed structures within said coating layer such that electrical pathways are formed which span the thickness of said coating, creating matrix of electrically conductive pathways from the surface of said coating to the base of said coating. In this manner said coating may contain a dielectric binder, such as polyurethane, and a conductive filler, such as carbon black, and maintain a very low electrical resistivity once said coating and curing processes are complete.

The next of said morphological and structural characteristics is the existence of electrically conductive fibers and/or electrically conductive particles, within one or more of the coating layers of said finished leather material. Said long fibers (for example long chain carbon black, or silver coated polymer fibers) form a structure within said coating layer or layers in which said fibers and or particles overlap one another in such a manner that said coating may undergo tensile, compressive, or shear strains (deformations) without suffering significant loss of electrical conductivity. As the leather material and the coating layer are deformed, said fibers and/or particles may experience small amounts of relative displacement yet maintain sufficient electrical conductivity so that said overall leather mater continues to maintain the desired electrical conductivity and capacitance.

In one exemplary embodiment of the invention, described here, a black colored leather material is produced with a volume resistivity of between 1.0×10³ and 1.0×10⁴ Ohm-cm, and a capacitance relative to a distant ground of between 50 pF and 500 pF. A tanned cattle leather is taken, having been tanned in a conventional leather tanning process using chromium salts. Said tanned leather is then colored in tumbling drum using a solution of carbon black leather pigment, water, ionic additives, and pH balancers.

Said leather is then removed from the tumbling drum and toggled to 50% of its maximum stretch, or toggle. Said toggled leather is dried while in this toggled state using a heater to accelerate the drying process.

Said toggled and dried leather is then removed from the toggling fixture and a base coat is applied, said base coat comprising:

| | |
|---|---|
| 160 parts | BU-AB, aliphatic polyurethane |
| 160 parts | water |
| 60 parts | Butyl Cellosolve Acetate |
| 72 parts | Ashbury 5303 long chain conductive carbon black |
| 84 parts | Consolidate Colors 459, carbon black based leather pigment |

Said base coat is sprayed onto the surface of said leather in such a manner as to uniformly and thoroughly coat said leather material. Said coated leather material is then cured, using heat to accelerate the curing process.

A mid-coat is then applied to said coated leather, said mid-coat comprising

| | |
|---|---|
| 1 part | BU72 Polyurethane |
| 1 part | BU-AB Polyurethane |
| 1 part | water. |

Said mid-coat is applied to said coated leather in a spray coating process to evenly and thoroughly coat said leather material. Said leather with said mid-coat is cured with heat to accelerate the curing process.

A finish coat is then applied to said coated and cured leather material, said finish coat comprising:

| | |
|---|---|
| 200 parts | 6017 CWB, Cellulose Acetate Butyrate |
| 100 parts | water |
| 18 parts | 33 Additive, waxy feel enhancer |

Said finish coat is applied to said coated leather material in a spray coating process to evenly and thoroughly coat said leather material. Said leather with said finish coat is cured with heat to accelerate the curing process.

Finally, said coated leather is milled by tumbling said coated and cured leather in a tumbler to restore flexibility and suppleness to said leather material.

In a second exemplary embodiment of the invention, described here, a red colored leather material is produced with a volume resistivity of between 1.0×10³ and 1.0×10⁴ Ohm-cm, and a capacitance relative to a distant ground of between 50 pF and 500 pF. A tanned cattle leather is taken, having been tanned in a conventional leather tanning process using chromium salts. Said tanned leather is then colored in tumbling drum using a solution of carbon black leather pigment, water, ionic additives, and pH balancers.

Said leather is then removed from the tumbling drum and toggled to 50% of its maximum stretch, or toggle. Said toggled leather is dried while in this toggled state using a heater to accelerate the drying process.

Said toggled and dried leather is then removed from the toggling fixture and a base coat is applied, said base coat comprising:

| | | |
|---|---|---|
| 66.6 | parts | BU-AB, aliphatic polyurethane |
| 160 | parts | water |
| 60 | parts | Butyl Cellosolve Acetate |
| 3.33 | parts | Ashbury 5303 long chain conductive carbon black |
| 30 | parts | Silver coated glass beads. |

Said base coat is sprayed onto the surface of said leather in such a manner as to uniformly and thoroughly coat said leather material. Said coated leather material is then cured, using heat to accelerate the curing process.

A color coat is then applied to said coated and cured leather material, said color coat comprising:

| | |
|---|---|
| 10 parts | BU72 Polyurethane |
| 5 parts | Red color pigment |
| 10 parts | Silver coated glass beads |
| 1 part | Ashbury 5303 long chain conductive carbon black |
| 10 parts | water. |

Said color coat is applied to said coated leather in a spray coating process to evenly and thoroughly coat said leather material. Said leather with said color coat is cured with heat to accelerate the curing process.

A mid-coat is then applied to said coated leather, said mid-coat comprising:

| | |
|---|---|
| 10 parts | BU72 Polyurethane; |
| 10 parts | BU-AB Polyurethane; |
| 10 parts | Silver coated glass beads; |
| 1 part | Ashbury 5303 long chain conductive carbon black; and |
| 10 parts | water. |

Said mid-coat is applied to said coated leather in a spray coating process to evenly and thoroughly coat said leather material. Said leather with said mid-coat is cured with heat to accelerate the curing process.

A finish coat is then applied to said coated and cured leather material, said finish coat comprising:

| | |
|---|---|
| 200 parts | 6017 CWB, Cellulose Acetate Butyrate |
| 100 parts | Silver coated glass beads |
| 10 parts | Ashbury 5303 long chain conductive carbon black |
| 100 parts | water |
| 18 parts | 33 Additive, waxy feel enhancer |
| 10 parts | UV protective additive |

Said finish coat is applied to said coated leather material in a spray coating process to evenly and thoroughly coat said leather material. Said leather with said finish coat is cured with heat to accelerate the curing process.

Finally, said coated leather is optionally milled by tumbling said coated and cured leather in a tumbler to restore flexibility and suppleness to said leather material.

### Glove Embodiments

The modified materials of the invention may be used in a number of capacities as described above allowing a user to operate a capacitive touch screen. As shown in the drawings, the described embodiments of the modified material of the invention are embodied in a conductive glove, wherein the conductive glove allows a user of the conductive glove to operate a touch screen device without removing the glove.

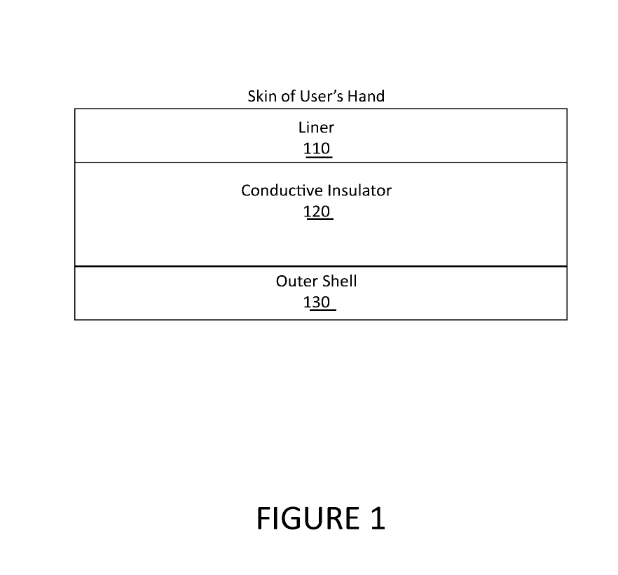

FIG. 1 shows a cross-section of an embodiment of an electrically conductive glove. This embodiment includes a liner 110, a conductive insulator 120 and an outer shell 130. It is to be understood that this is a cross-section of at least a portion of the glove. That is, the entire glove is not required to be fabricated as shown. In an application, the glove is worn by a user of a touch screen device. An embodiment includes the portion of the glove that the user uses to control the touch screen device being fabricated as shown by the cross-section view of FIG. 1.

For an embodiment, the liner and outer shell being less than 2 mm thick and/or has a volume resistivity of less than 1.0×10⁷ Ohm-cm and/or a surface resistivity of less than 1.0×10⁸ Ohm-cm. When any material has an electrical volume resistivity level of less than 1.0×10⁷ Ohm-cm or a surface resistivity of less than 1.0×10⁸ Ohm-cm it is widely considered to be in the range of a conductive material. This is desirable because a capacitive coupling with the touch screen is not possible if the non-conductive liner and/or the outer shell is thicker than 2 mm and not made of a conductive material.

In order to properly operate a capacitive touch screen device with gloves on, without the use of a device, such as a stylus or other embodiment specifically created for this purpose, the glove itself must provide a capacitive coupling to the human skin. This can be achieved by employing/using material as described throughout that will not block the conductivity to the human skin surface. When a fabric or material is used that is either too thick, or has a volume resistivity of greater than 1.0×10⁷ Ohm-cm and/or a surface resistivity of greater than 1.0×10⁸ Ohm-cm, the results are a material that is electrically dissipative or insulative, not conductive and therefore will not work for this application.

Various embodiments of the liner include at least one of rayon, acetate, nylon, modacrylic, olefin, PLAY polyester, wool, cotton, silk, acrylic, blends or any type of conductive woven fiber blends, metallic fibers or fibers treated with copper, silver, carbon black, carbon fiber, nickel, tin or other conductive material with a thickness of less than 2 mm and/or a volume surface resistivity of less than 1.0×10⁷ Ohm-cm and/or a surface resistivity of less than 1.0×10⁸ Ohm-cm.

For an embodiment, the electrically conductive insulator layer is located adjacent to the liner. Additionally, this embodiment includes a resistance of the electrically conductive insulator layer being less than 1.0×10⁷ Ohm-cm.

Embodiments of the electrically conductive thermal insulator layer include a conductive foam, fiber, microfiber, microfilament, plastic, metal, rubber or breathable thermal insulation with a volume resistivity of less than 1.0×10⁸ Ohm-cm and/or a surface resistivity of less than 1.0×10⁸ Ohm-cm.

Configurations of the conductive fiber, microfiber, microfilament or breathable thermal, electrically conductive, thermal insulation include materials made from different mixtures of polymers, but primarily Polyethylene terephthalate or a mixture of Polyethylene terephthalate and polypropylene. Other materials may include polyethylene terephthalate, polyethylene isophthalate copolymer and acrylic in combination with a conductive coating or impregnated, embedded, compounded or plated conductive material with a surface resistivity of less than 1.0×10⁸ Ohm-cm. This can be accomplished by the use of a chemical reaction to bond the molecules of carbon black, copper, silver, gold, nickel, tin or other conductive metal substances, with the molecules of the host fiber, or by plating or compounding any of these conductive substances to the host fiber.

Other embodiments of the electrically conductive insulator layer include a conductive foam, rubber, fiber, microfiber or microfilament.

For an embodiment, the outer shell is formed adjacent to the electrically conductive insulating layer. Additionally, this embodiment includes the outer shell being less than 2 mm thick and/or having a volume resistivity of less than 1.0×10⁷ Ohm-cm.

This is desirable because a capacitive coupling with the touch screen is not possible if the non-conductive liner and/or the outer shell is thicker than 2 mm and not made of a conductive material.

In order to properly operate a capacitive touch screen device with gloves on, without the use of a device, such as a stylus or other embodiment specifically created for this purpose, the glove itself must provide a capacitive coupling to the human skin. This can be achieved by employing or using key types of fabrics or other materials that will not block the conductivity to the human skin surface. When a fabric or material is used that is either too thick, or has a volumetric and/or surface resistivity of greater than 1.0×10⁷ Ohm-cm, the results are a material that is electrically dissipative or insulative, not conductive and therefore will not work for this application.

Embodiments of the outer shell include rayon, acetate, nylon, modacrylic, olefin, PLA, polyester, wool, cotton, silk, acrylic, blends or any type of conductive woven fiber blends; metallic fibers or fibers treated with copper, silver, carbon black, carbon fiber, nickel, tin, other conductive material, animal skin, vinyl, rubber, latex or silicone.

The embodiment of FIG. 1 can be fabricated by using a piece of fabric made of wool, cotton or silk as a liner, for instance, and securing it to a layer of electrically conductive thermally insulative foam, or electrically conductive thermally insulative microfiber insulation, for instance, and securing the insulation to the outer shell. When all components of the glove meet the specifications of both thickness and conductivity. By simply pressing the skin firmly against the three layers of material will produced the desired results of creating a capacitive coupling through the dielectric and conductive surfaces to the touch screen device and allows the user to use the device as if they were touching the device with their bare skin.

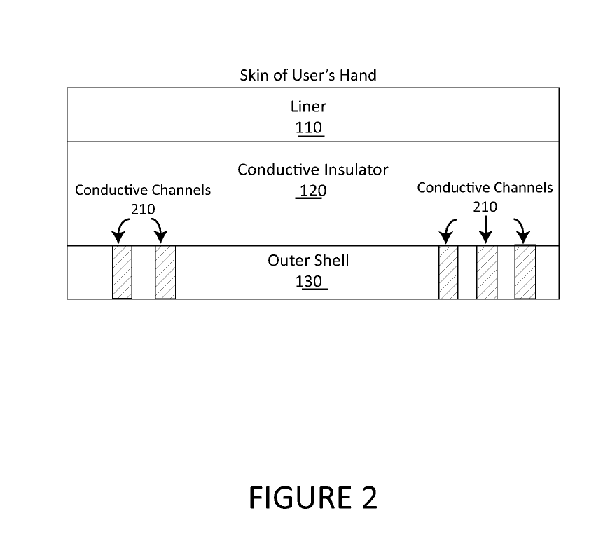

FIG. 2 shows a cross-section of another embodiment of an electrically conductive glove. This embodiment additionally includes at least one conductive channel 210. Each of the conductive channels 210 extends from an inner surface of the outer shell 130 to an outer surface of the outer shell 130

Embodiments of the conductive channels 210 include conductive material which may include resins, polymers, plastics, rubbers, foams, fibers, metals, epoxies or adhesives. The conductive channels provide enhanced conductivity between the skin of the user's hand and the external surface of the glove as defined by the outer surface of the outer shell 130.

One method of manufacturing the conductive channels includes perforating the outer shell material (before forming the glove with the conductive thermal insulator 120 and the liner 110) and filling the perforations with a conductive gel, adhesive, resin, foam, plastic, metal or fibrous substrate that meets the criteria of being conductive. The number of perforations can number from one to as many as desired in differing diameters, for the purpose of covering the surface area adequately to allow the user to interact with the device in the same manner they would if they were not wearing gloves. The perforations can be spaced in specific patterns for either aesthetic design or for materials that would normally be weakened by holes in material to allow for the strength of the material to not be compromised, provided that the function of allowing conductive interaction between the user and the device are not compromised.

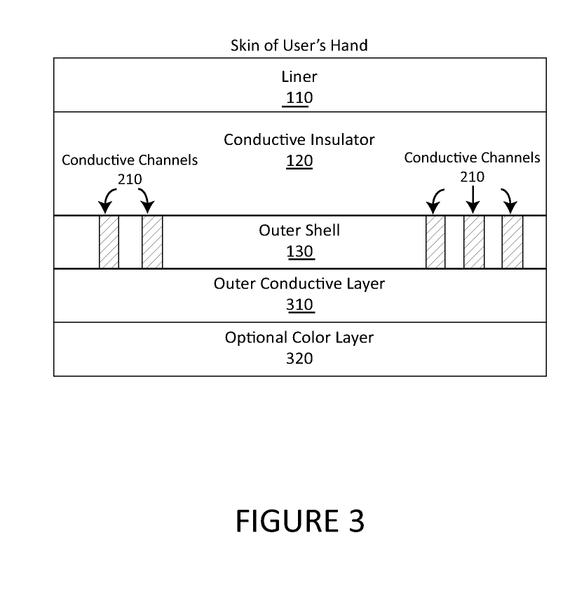

FIG. 3 shows a cross-section of another embodiment of an electrically conductive glove. This embodiment additionally includes an outer conductive layer 310 adjacent to the outer surface of the outer shell.

Embodiments of the outer conductive layer 310 include a base coating of polyurethane, polyepoxide, paint, adhesive, sealant, silicone, resins, polymers, plasticizers, vinyl compounds, metals or plastics materials with an added electroconductive carbon, silver, nickel, copper, tin, gold or other conductive metal or alloy into the coating in high concentrations to achieve a volume resistivity of less than 1.0×10⁷ Ohm-cm which may or may not be specifically used to mimic the color, grain, texture and feel of the outer surface of the outer shell.

An optional additional layer includes a color layer 320 adjacent the outer conductive layer 310. Embodiments of the color layer are primarily aesthetic, and can be used to determine a glove color, texture, grain or appearance.

A method of manufacturing the glove structure as shown in FIG. 3 include, for example, an organic or inorganic fabric or material that is designed for the comfort and warmth of the user and functions as a method of wicking away moisture while allowing conductance to take place. The materials may be made of cotton or wool, for instance and meet the criteria of thickness and conductance needed. adjacent to the liner would be the electrically conductive thermally insulative material, adjacent to the insulative material would be the outer shell with the conductive channels. adjacent to the outer shell would be an outer conductive layer, which may or may not be colored or textured to match the outer surface of the outer shell.

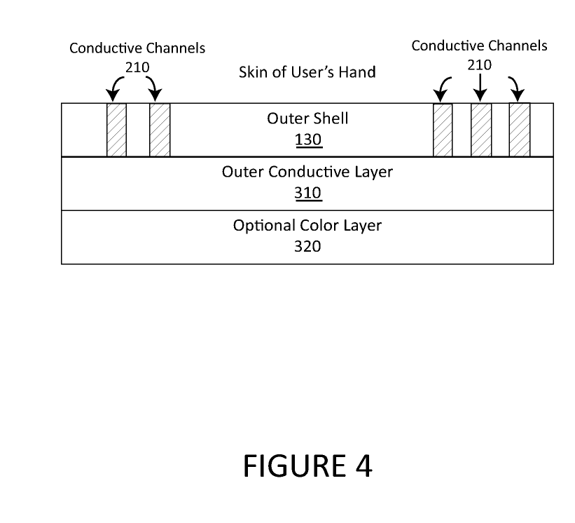

FIG. 4 shows a cross-section of another embodiment of an electrically conductive glove. This embodiment includes an outer shell 130. As shown, the outer shell 130 includes at least one conductive channel 210. Each of the conductive channels extend from an inner surface of the outer shell 130 to an outer surface of the outer shell 130. For an embodiment, each of the conductive channels has a volume and/or surface resistivity of less than 1.0×10⁷ Ohm-cm.

Perforating the outer shell material (before forming the glove with the conductive thermal insulator 120 and the liner 110) and filling the perforations with a conductive gel, adhesive, resin, foam, plastic, metal or fibrous substrate that meets the criteria of being conductive. The number of perforations can number from one to as many as desired in differing diameters, for the purpose of covering the surface area adequately to allow the user to interact with the device in the same manner they would if they were not wearing gloves. The perforations can be spaced in specific patterns for either aesthetic design or for materials that would normally be weakened by holes in material to allow for the strength of the material to not be compromised, provided that the function of allowing conductive interaction between the user and the device are not compromised.

Alternate embodiments can additionally include one or more outer conductive layers 310 adjacent to the outer surface of the outer shell 310. The addition of the conductive layer 310 provides the ability to use less perforations, as few as one, that can be strategically placed in inconspicuous areas of the glove and provide a capacitive coupling anywhere on the treated surface of the outer surface of the outer shell.

A method of manufacture for the outer conductive layer includes, for example thin coat of conductive coating bonded to the outer surface of the outer shell by means of spraying, painting, heat/pressure bonding or by the use of a conductive adhesive material.

Another embodiment includes a color layer 320. Embodiments of the color layer 320 color layer are primarily aesthetic, and can be used to determine a glove color, texture, grain or appearance.

The color layer can be formed by use of a chemical bonding, mechanical bonding or by spraying, painting, heat/pressure bonding or by the use of a conductive adhesive or primer coating.

### Additional Glove Embodiments

Additional embodiments of the glove are discussed below. In one embodiment, the invention is directed to a conductive glove comprising: a liner, the liner being less than 2 mm thick and/or having a resistance of less than 1.0×10⁷ Ohm-cm;

an electrically conductive insulator layer, with a resistance of less than 1.0×10⁷ Ohm-cm, adjacent to the liner; and an outer shell adjacent to the electrically conductive insulating layer, the outer shell being less than 2 mm thick and/or having a resistance of less than 1.0×10⁷ Ohm-cm.

In one embodiment, the glove when worn by a user, at least a portion of the liner physically contacts the user's hand. The liner optionally may comprise at least one component selected from of rayon, acetate, nylon, modacrylic, olefin, PLAY polyester, wool, cotton, silk, acrylic, blends or conductive woven fiber blends, metallic fibers or fibers treated with copper, silver, carbon black, carbon fiber, nickel, tin or other conductive material with a thickness of less than 2 mm and/or a volume resistivity of less than 1.0×10⁷ Ohm-cm and/or a surface resistivity of less than 1.0×10⁸ Ohm-cm.

The electrically conductive thermal insulator layer comprises a conductive foam, fiber, microfiber, microfilament, plastic, metal, rubber or breathable thermal insulation with a volume resistivity of less than 1.0×10⁷ Ohm-cm and/or a surface resistivity of less than 1.0×10⁸ Ohm-cm.

The conductive fiber, microfiber, microfilament or breathable thermal, electrically conductive, thermal insulation comprises materials made from different mixtures of polymers, but primarily polyethylene terephthalate or a mixture of polyethylene terephthalate and polypropylene. Other materials may include polyethylene terephthalate, polyethylene isophthalate copolymer and acrylic in combination with a conductive coating or impregnated, embedded, compounded or plated conductive material with a surface resistance of less than 1.0×10⁷ Ohm-cm. This can be accomplished by the use of a chemical reaction to bond the molecules of carbon black, copper, silver, gold, nickel, tin or other conductive metal substances, with the molecules of the host fiber, or by plating or compounding any of these conductive substances to the host fiber.

The electrically conductive thermal insulator layer comprises a conductive foam, rubber, fiber, microfiber or microfilament.

The outer shell may comprise at least one conductive channel, the conductive channel extending from an inner surface of the outer shell to an outer surface of the outer shell. The glove may further comprise an outer conductive layer adjacent to the outer surface of the outer shell. The outer conductive layer comprises a base coating of polyurethane, polyepoxide, paint, adhesive, sealant, silicone, resins, polymers, plasticizers, vinyl compounds or plastics materials with an added electro-conductive carbon, silver, nickel, copper, tin, gold or other conductive metal or alloy into the coating in high concentrations to achieve a surface and/or volumetric resistivity of less than 1.0×10⁷ Ohm-cm which may or may not be specifically used to mimic the color, grain, texture and feel of the outer surface of the outer shell.

The glove may also have a color layer adjacent the outer conductive layer, the color layer determining a glove color, texture, grain or appearance.

In another embodiment, the invention is directed to a conductive glove comprising: an outer shell, the outer shell comprising at least one conductive channel, the conductive channel extending from an inner surface of the outer shell to an outer surface of the outer shell, the conductive channel having a resistivity of less than 1.0×10⁷ Ohm-cm. The glove may also have one or more outer conductive layers adjacent to the outer surface of the outer shell.

In another embodiment is provided a conducting glove comprising a non-conductive dielectric outer shell, the non-conductive outer shell being less than 2.0 mm thick an electrically conductive thermal insulator layer, with a volume resistivity of less than 1.0×10⁷ Ohm-cm, adjacent to the liner; and an inner liner adjacent to the electrically conductive insulating layer, the inner liner being less than 2.0 mm thick or with a volume resistivity of less than 1.0×10⁷ Ohm-cm where the capacitive touch screen is capacitively coupled to the conductive thermal insulator layer, which in turn is electrically conductive to the conductive inner liner, which in turn is electrically conductive to the user's skin. The conducting and insulating layers are located only at specific locations on the glove, such as the finger and thumb tips.

In another embodiment, is provided a conducting glove comprising a non-conductive dielectric outer shell, the non-conductive outer shell being less than 2.0 mm thick an electrically conductive thermal insulator layer, with a volume resistivity of less than 1.0×10⁷ Ohm-cm, adjacent to the liner; and a non-conductive dielectric inner liner adjacent to the electrically conductive insulating layer, the inner layer being less than 2.0 mm thick where the capacitive touch screen is capacitively coupled to the conductive thermal insulator layer, which in turn is capacitively coupled to the user's skin. The conducting and insulating layers are located only at specific locations on the glove, such as the finger and thumb tips.

In still another embodiment is provided a conducting glove comprising an electrically conductive outer shell, the electrically conductive outer shell with a volume resistivity of less than 1.0×10⁷ Ohm-cm an electrically conductive thermal insulator layer, with a volume resistivity of less than 1.0×10⁷ Ohm-cm, adjacent to the liner; and a non-conductive dielectric inner liner adjacent to the electrically conductive insulating layer, the inner liner being less than 2.0 mm where the capacitive touch screen is electrically conductive to the outer shell, which in turn is electrically conductive to the thermal insulator layer, which is capacitively coupled to the user's skin 18. The conducting and insulating layers are located only at specific locations on the glove, such as the finger and thumb tips. The conductive fiber, microfiber, microfilament or breathable thermal, electrically conductive, thermal insulation comprise materials made from different mixtures of polymers, but primarily polyethylene terephthalate or a mixture of Polyethylene terephthalate and polypropylene. Other materials may include polyethylene terephthalate, polyethylene isophthalate copolymer and acrylic in combination with a conductive coating or impregnated, embedded, compounded or plated conductive material with a surface resistance of less than 1.0×10⁷ Ohm-cm. This can be accomplished by the use of a chemical reaction to bond the molecules of Carbon Black, copper, silver, gold, nickel, tin or other conductive metal substances, with the molecules of the host fiber, or by plating or compounding any of these conductive substances to the host fiber.

The electrically conductive insulator layer may comprise a conductive foam, rubber, fiber, microfiber or microfilament.

The outer shell may comprise at least one conductive channel, the conductive channel extending from an inner surface of the outer shell to an outer surface of the outer shell. The glove may further comprise an outer conductive layer adjacent to the outer surface of the outer shell.

The outer conductive layer comprises a base coating of polyurethane, polyepoxide, paint, adhesive, sealant, silicone, resins, polymers, plasticizers, vinyl compounds or plastics materials with an added electro-conductive carbon, silver, nickel, copper, tin, gold or other conductive metal or alloy into the coating in high concentrations to achieve a surface and/or volumetric resistance of less than 1.0×10⁷ which may or may not be specifically used to mimic the color, grain, texture and feel of the outer surface of the out shell.

The glove may further comprise a color layer adjacent the outer conductive layer, the color layer determining a glove color, texture, grain or appearance.

In still yet another embodiment, the invention is directed to a conductive glove comprising: an outer shell, the outer shell comprising at least one conductive channel, the conductive channel extending from an inner surface of the outer shell to an outer surface of the outer shell, the conductive channel having a resistance of less than 1.0×10⁷ ohm-cm. The glove may further comprise one or more outer conductive layers adjacent to the outer surface of the outer shell.

Also encompassed by the invention is a glove with a non-conductive layer, but that allows capacitive coupling between the screen and a conductive insulation material, or between the conductive insulation material and the finger.

In yet another embodiment, the invention is directed to a conductive or capacitively coupled glove that is only locally conductive or capacitively coupled, for example in the finger tip but not elsewhere. a glove that is a single conductive layer, for example just an outer shell.

In the following embodiment and method an electrically conductive glove suitable for interaction with a capacitive touch screen is described. An electrically conductive glove of the invention is fabricated in such a manner that the glove material, which may be non-conductive, or dielectric, initially, is coated, or treated, with a thin film of a conductive material. The material of the glove, for example leather, faux leather, suede, polymer, wool, cotton, fur, nylon, fleece, or any other suitable material, is coated in such a way that an electrically conductive surface layer is created on the outside of the glove. This electrically conductive coating may or may not penetrate into the material of the glove, but must a form an electrically conductive surface or surface layer when coated. In this manner the electrically conductive coating creates an electrical capacitance relative to a distant ground, or to the capacitive touch device, sufficient to be detected by a capacitive touch device with or without any grounding to a user or other ground source. To affect such an electrical capacitance, the surface area, geometry of the coating, electrical conductivity, and/or the volume of conductive material are sufficient to create an electrical capacitance relative to a distant ground, or to the capacitive touch device, sufficient to be detected by the capacitive sensors in the capacitive touch device. The conductive coating may be electrically conductively connected to the user, it may be electrically capacitively coupled to the user, or it may be electrically isolated.

A method for manufacturing of the electrically conductive glove described above is described here. A glove material is coated with an electrically conductive coating in such a manner as to coat the surface, penetrate the glove material, fill pores in a porous material, fill pores in a fibrous material, coat the fibers of a fibrous material, or otherwise render the material electrically conductive on or near its surface. The electrically conductive coating material may be generally manufactured by using a carrier, for example a plasticizer, a bulk polymer like acrylic, a weather proofing, a leather conditioner, an enamel, or any other suitable carrier, and filling said carrier with an electrically conductive medium, such as powdered carbon in the form of graphite or carbon black, powdered metal like silver, powdered indium-tin-oxide (ITO), electrically conductive polymers, or other powdered electrically conductive material or materials. The electrically conductive material may also be manufactured as a solution of one or more conductive materials, in one or more carriers and/or solvents. Said electrically conductive coating material is then applied to said glove material in such a fashion as to coat the surface, bond to the surface, and/or penetrate the surface in such a fashion as to create an electrically conductive surface, or near surface, layer on said glove material Such electrical volume conductivities of said electrically conductive glove materials should preferably be less than 1.0×10⁷ Ohm-cm, more preferably less than 1.0×10⁶ Ohm-cm, and most preferably less than 1.0×10⁵ Ohm-cm.

A glove pattern is then cut from said electrically conductive material and fabricated in any standard or non-standard glove fabrication process such that the electrically conductive surface is positioned preferably on the outside of one or more of the materials of the finished glove.

In embodiments, the electrically conductive surface is positioned on the inside of one or more of the materials of the finished glove.

Back Coating

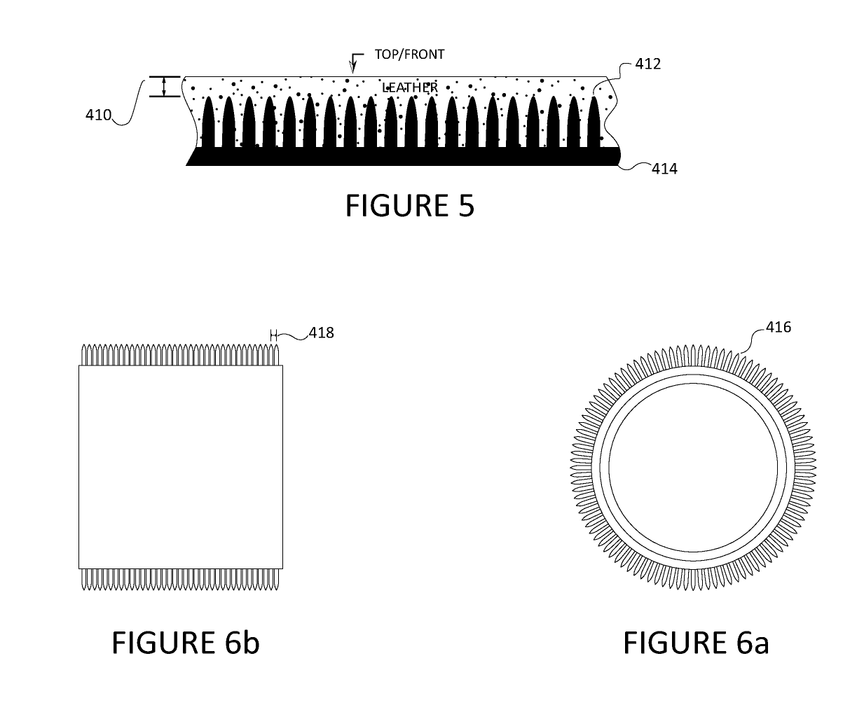

With reference to FIG. 5, another glove is made from a glove material comprising a plurality of wells 412 or cavities on its backside which do not extend all the way through the glove material. The wells are filled with a conductive material 414 as described herein. The presence of the wells on the backside of the glove material does not affect the surface color, characteristics, softness and other treatments, like fire and water resistance. Consequently, a glove material such as tanned leather may be made operable for use with a capacitive based touch screen without degrading or altering the front surface of the leather.

The wells preferably extend to a depth in the glove material such that a floor remains from the bottom of the well to the top/front surface or grain as shown in FIG. 5. The floor thickness 410 or (T_{FLOOR}) may vary. Too large a thickness results in the glove not affecting the touch screen. Too small a thickness results in degrading the front surface of the glove material (e.g., bleeding, texture variation). Preferably the thickness (T_{FLOOR}) ranges from 0.1 to 0.6 mm, and more preferably is about 0.3 to 0.5 mm, and about 0.4 mm or in embodiments is about the thickness of a piece of paper, thereby enabling the coupling, as if the screen were being touched by skin.

In embodiments, the cavities extend to a floor surface, and the floor surface is less than or equal to 0.2 mm from the front surface of the glove material.

Additionally, the wells are set at a distance on center to match what the standard array of capacitors are on modern touch screens, thereby ensuring the sensors will detect attenuation. For example, the wells may be set in a diamond pattern, 2 mm on center. If the spacing is too far apart, the screen sensors will not detect attenuation. Preferably, the center to center distance between the pins ranges from 1 to 4 mm, and more preferably between 2-3 mm.

Pin Wheel

The above described glove may be manufactured variously. One method of manufacturing a glove comprises the steps of puncturing the back surface of the glove material with an array of pins to create a plurality of cavities extending into the backside of the glove material.

FIGS. 6a-6b are front and side views respectively of a tool, namely, a pin wheel for creating cavities or wells in the glove material. The pin wheel shown in FIGS. 6a-6b is intended to be rolled against the glove material. In particular, the wheel is manipulated such that the pins 416 are rolled across the back surface of the glove material, creating wells in the glove material. The pins 416 shown in FIGS. 6a-6b are 19 gauge pins, 5/16″ in length, and 3 mm on center. The pins are shown in a 2 mm by 2 mm diamond configuration (an exemplary center to center is distance 418 is about 2 mm) The tips of the pins shown in FIGS. 6a-6b are bullet nose. However, it is to be understood that the pins, and pin pattern shown and described in this embodiment are exemplary. The invention is intended only to be limited to that recited in the appended claims. In embodiments, a method additionally comprises applying an electrically conductive agents and binders to fill the cavities. The conductive agent may be applied via a screen printer or roller. In embodiments, a magnetic bar may be incorporated into the process to apply significant downward pressure into the glove material to facilitate driving the conductive material deep into the cavities.

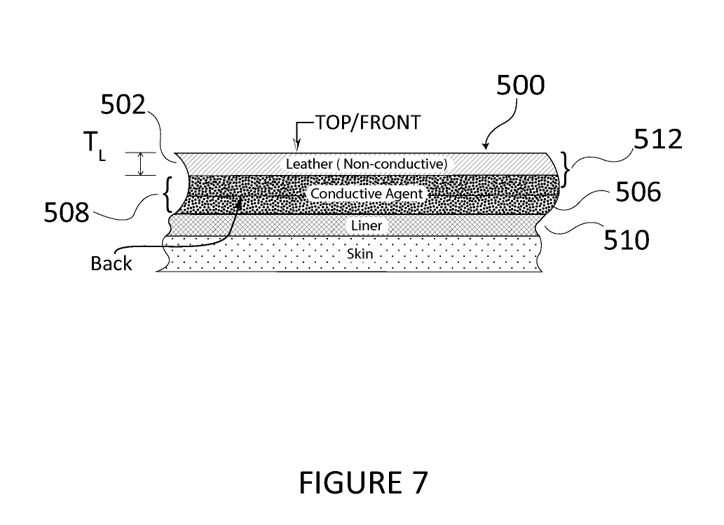

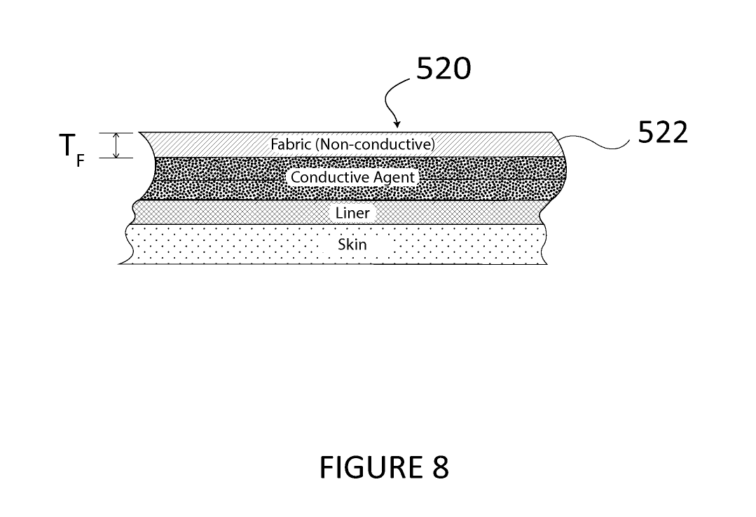

In embodiments, and with reference to FIG. 7, a cross section of an electrically conductive glove material 500 is shown having a top or outer non-conductive layer 502, a conductive agent zone 508, and an inner liner 510. The conductive agent zone 508 is shown overlapping with the leather layer 512 to some degree. However, the outer layer 502 is substantially free of the electrically conductive material. Non-conductive outer layer preferably has a thickness T_{L} ranging from 0.1 to 0.6 mm, more preferably from 0.3 to 0.5 mm, and even more preferably about 0.4 mm. In embodiments, the thickness is about the same as a piece of paper, thereby enabling the coupling, as if the screen were being touched by skin.

The electrically conductive agent layer 508 is shown coating and/or impregnating into the leather 512. In embodiments, the electrically conductive agent layer impregnates the leather with the electrically conductive material to result in a resistance per square area following treatment of 1×10⁴ to 1×10⁵ ohms per cm², or such that use of the material may operate a capacitive touch screen device.

In embodiments, a method to impregnate the electrically conductive agent into the leather comprises back coating the leather by applying the agents and preferably binders in a solution form, and measuring and controlling the solution volumetric uptake. In embodiments, the volumetric uptake range is 60-80% or about 65-75%, and most preferably about 70-75% of the leather must contain the conductive solution.

However, as stated herein, a top layer preferably remains free of the electrically conductive material. To verify the uptake quantities and that the top layer remains free of the electrically material, one may cut a sample and visually look at the cross section or measure the depth of penetration of the solution through the leather. The processes (examples of which are described below) are adjusted to ensure that the electrically conductive solution does not penetrate too deep.

Rollers

One technique to apply the EC solution to the leather comprises roll coaters. The leather is fed through a roller pair (e.g., an upper and lower roller). When treating leather, the grain side is up, and fed through the opening between the rollers. An EC solution is applied to the side opposite the grain (e.g., from a bath of the solution). The speed and compression, amongst other things, is adjusted to obtain the desired volumetric uptake.

High volume low pressure (HVLP) air gun. An EC solution is sprayed onto the back surface of the leather using jets, e.g. mini jets. The jets may be positioned 2-5 inches from the leather surface. The leather may be held in place for a time period, allowing the solution to impregnate the leather. Then, volumetric uptake is measured. The volumetric uptake may further be controlled by adjusting the viscosity of the conductive solution. For thin leather, one may increase the viscosity of the solution. For thicker leather, one may decrease the viscosity so as to speed up the volumetric uptake.

Screen Printing

Screen printing may be employed to apply a coating of the EC solution to the material. Without being bound to theory, screen printing is more desirable when treating thinner substrates because the uptake and penetration of the EC solution is not as great as some of the other techniques described herein.

Vacuum

To increase the rate of solution volumetric uptake, a vacuum may be applied to the substrate to pull the solution into the leather. In embodiments, a vacuum table may support the leather or article to be treated, and a vacuum pulls the solution into the leather until the desired depth of penetration or uptake is reached. Such a process may be automated as desired and an assembly line may be set to apply solution, draw vacuum, and print onto the backside of the material. Rotating tables or longitudinally-moving conveyors may transport the leather as vacuum is being applied.

FIG. 8 shows a cross section of another electrically conductive glove material 520 having a top or outer non-conductive layer 522, a conductive agent zone, and an inner liner. The layers are similar to the layers described in FIG. 7 except that outer material is a fabric instead of leather. In embodiments the thickness (T_{F}) of the non-conductive layer is the same as T_{L} described herein

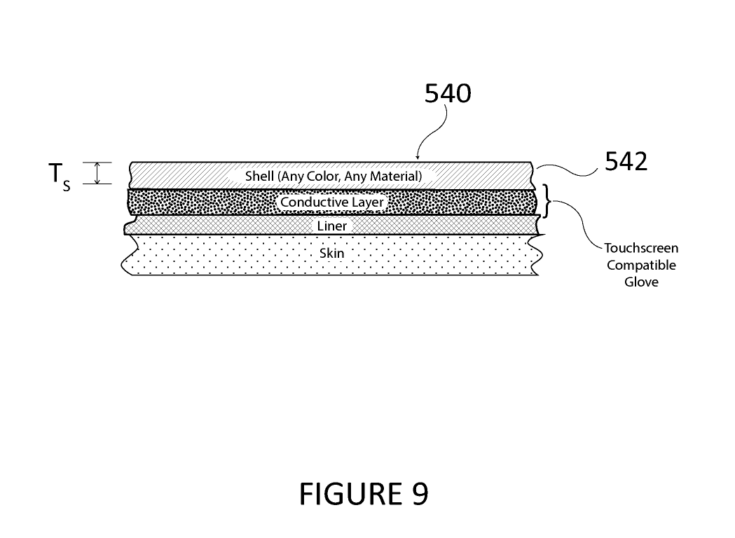

FIG. 9 shows another a cross section of another electrically conductive glove material 540 having a top or outer non-conductive layer 542, a conductive agent zone, and an inner liner. The layers are similar to the layers described in FIGS. 7-8 except that outer material is a shell layer of any material and any color. In embodiments the thickness (T_{S}) of the non-conductive layer is the same as T_{L} described herein.

In embodiments, an electrically conductive coating is applied to the backside of the glove material. If the glove material has a material thickness (e.g., when compressed by hand or tool) equal to or less than T_{S}, there is no need to further impregnate the EC material because the thickness of the material is sufficient to create the capacitive coupling. If the material thickness is greater than T_{S}, the electrically conductive agents and binders are impregnated into the backside of the raw glove material in accordance with methods described herein.

The glove material is cut to shape, and the component portions are sewn or affixed together as desired.

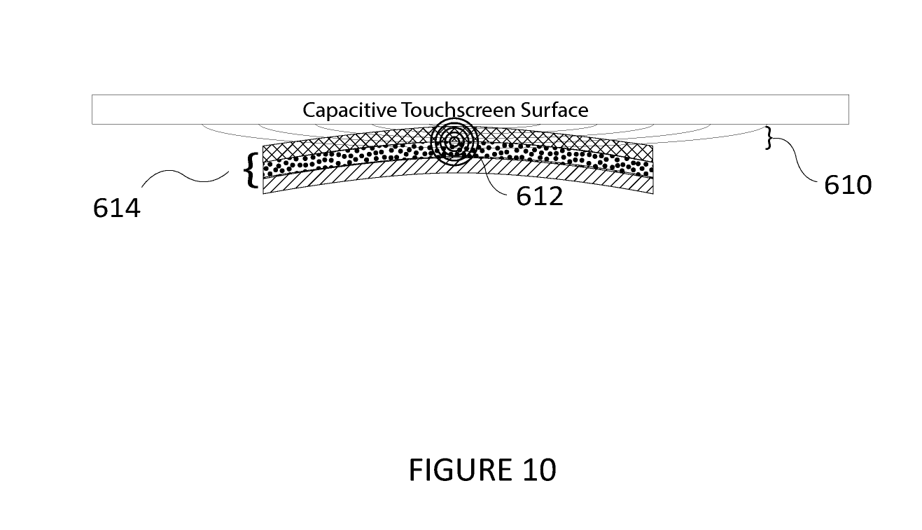

FIG. 10 is an illustration of a capacitive touch screen surface showing an EM field 610, and attenuation 612 of the EM field from a glove 614 made in accordance with embodiments of the present invention. A diameter of the glove portion to contact the screen is about 4.5 mm.

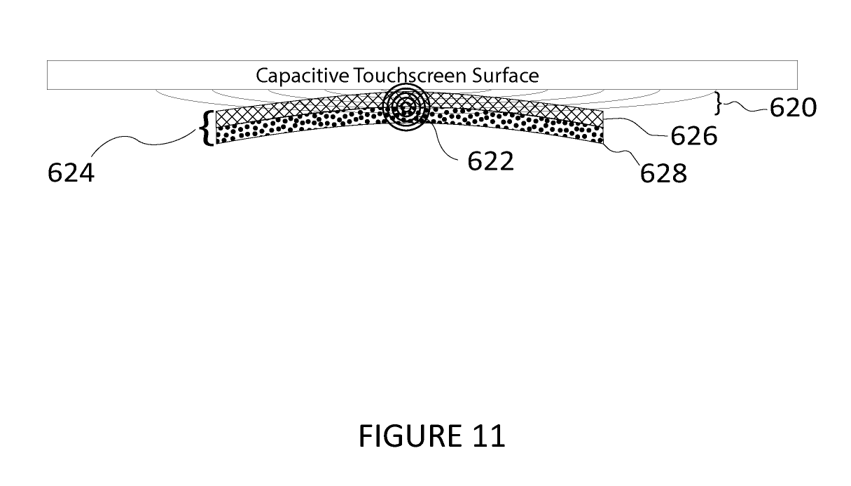

FIG. 11 is an illustration of a capacitive touch screen surface showing an EM field 620, and attenuation 622 of an EM field from a human finger 624. The finger 624 comprises a skin layer 626 covering a subcutaneous layer 628. Diameter of the finger tip is about 4.5 mm.

Other modifications and variations can be made to the disclosed embodiments without departing from the subject invention.

We claim:

1. A conductive glove for use with capacitive based touch screen displays, said glove comprising:
a glove material including a front surface and a back surface;
a plurality of cavities extending into the glove material from the back surface, said cavities not extending all the way through the glove material to the front surface; and
a conductive material filling the cavities.

2. The glove of claim 1, wherein the cavities extend to a floor surface, said floor surface being about 0.03 inches from the front surface of the glove material.

3. The glove of claim 1, wherein the glove material is leather.

4. A method of manufacturing a glove for use with capacitive based touch screen displays comprising: puncturing a back surface of a glove material with an array of pins to create a plurality of cavities in the back surface of the glove material wherein the cavities do not extend completely through the glove material; and filling the cavities with a conductive material.

5. The method of claim 4, wherein the puncturing step is performed by supporting the glove material on a rigid substrate, and rolling a pin wheel comprising the array pins across the glove material.

6. The method of claim 4, wherein the cavities extend to a floor surface, and said floor surface being about 0.03 inches from the front surface of the glove material.

7. The method of claim 4, wherein a pin to pin distance ranges from 2-5 mm.

8. The method of claim 4, wherein the array of pins comprise a diamond pattern.

9. The method of claim 4, wherein the pins comprise a bullet nose shape.

10. The method of claim 4, wherein the pins are 18-20 gauge.

11. A method of making an electrically conductive glove from a glove material, the method comprising:
measuring the thickness of the glove material;
determining a target volumetric uptake or depth of penetration value based on the thickness of the glove material;
applying an EC solution to the back of the glove material;
measuring the volumetric uptake of the EC solution into the material; and
adjusting at least one process condition based on the measuring step and the determining step.

12. The method of claim 11, wherein the applying step comprises impregnating the back of a leather material with the EC solution such that the electrically conductive agents do not penetrate to within a T_{L} from the front of the leather material, and wherein the T_{L} ranges from 0.1 to 0.6 mm.

13. The method of claim 11, wherein the glove material comprises a shell front layer, and the applying step comprises impregnating the back of the glove material with the EC solution such that the electrically conductive agents do not penetrate to within a T_{S} from the front of the material, and wherein the T_{S} ranges from 0.1 to 0.6 mm.

14. The method of claim 11, wherein the applying step comprises impregnating the back of a fabric material with the EC solution such that the electrically conductive agents do not penetrate to within a T_{F} from the front of the material, and wherein the T_{F} ranges from 0.1 to 0.6 mm.

15. The method of claim 11, further comprising puncturing the back surface of the glove material with an array of pins to create a plurality of cavities in the back surface of the glove material.

16. The method of claim 15, wherein the step of puncturing creates the plurality of cavities such that the cavities do not extend completely through the glove material.

17. The method of claim 15, wherein the applying step comprises impregnating the back of a leather material with the EC solution such that the electrically conductive agents do not penetrate to within a T from the front of the leather material, wherein T is less than or equal to 1 mm.

18. The method of claim 15, wherein the applying step comprises a process selected from the group consisting of vacuum, screen printing, rollers, and puncturing.

19. The method of claim 11, wherein the applying step comprises impregnating the back of the glove material with the EC solution such that the electrically conductive agents do not penetrate to within 0.2 mm from the front surface of the glove material.
